(19) United States
(12) Patent Application Publication
(10) Pub. No.: US 2025/0162933 A1
(43) Pub. Date: May 22, 2025

(54) MANUFACTURING METHOD OF GLASS SUBSTRATE AND MANUFACTURING APPARATUS OF GLASS SUBSTRATE

(71) Applicant: Samsung Display Co., Ltd., Yongin-Si (KR)

(72) Inventors: Dong-Su YEE, Yongin-si (KR); JI-MAN PARK, Yongin-si (KR)

(21) Appl. No.: 18/805,535

(22) Filed: Aug. 15, 2024

(30) Foreign Application Priority Data
Nov. 16, 2023 (KR) 10-2023-0159079

(51) Int. Cl. C03C 27/04

(52) U.S. Cl. CPC C03C 27/048

(57) ABSTRACT

An apparatus for manufacturing a glass substrate according to an embodiment includes a fixture coupled to an outermost glass substrate among a plurality of glass substrates, and a plate positioned between two adjacent glass substrates among the plurality of glass substrates, the plate includes a first base substrate including a protrusion and a second base substrate including a depression corresponding to the protrusion.

### CROSS-REFERENCE TO RELATED APPLICATION

This application claims priority to and the benefit of Korean Patent Application No. 10-2023-0159079 filed at the Korean Intellectual Property Office on Nov. 16, 2023, the entire contents of which are incorporated herein by reference.

### BACKGROUND

### (A) Field

The present disclosure relates to a method for manufacturing a glass substrate and an apparatus for manufacturing a glass substrate.

### (B) Description of the Related Art

Recently, with the increase in demand for smartphones, a new growth industry in electronic products related to flexible displays is in full swing.

To manufacture flexible displays, ultra-thin glass substrates (ultra-thin glass; referred to as UTG in the drawings) are used.

At this time, an ultra-thin glass substrate is tempered glass with a thickness of less than 100 micrometers, which is so thin that it takes less impact when folded or bent compared to regular glass and is unbreakable.

These ultra-thin glass substrates are not only difficult to manufacture compared to regular tempered glass substrates, but also have a high defect rate, so related companies are expanding their efforts to stabilize the manufacturing process, reduce defect rates, and reduce labor costs.

### SUMMARY

Embodiments are intended to provide a method for manufacturing a glass substrate and an apparatus for manufacturing a glass substrate that provide a round edge of the glass substrate.

An apparatus for manufacturing a glass substrate according to an embodiment includes a fixture coupled to an outermost glass substrate among a plurality of glass substrates, and a plate positioned between two adjacent glass substrates among the plurality of glass substrates, the plate including a first base substrate including a protrusion, and a second base substrate including a depression complementary to the protrusion.

The plate may include a first plate and a second plate, the first plate may include the first base substrate, and the second plate may include the second base substrate.

The first plate may further include a first adhesive layer disposed on a surface of the first base substrate.

The second plate may further include a second adhesive layer disposed on a surface of the second base substrate.

When the first base substrate and the second base substrate are combined, a space may be disposed between the depression and the protrusion.

The width of the depression may be greater than the width of the protrusion.

The height of the depression may be greater than the height of the protrusion.

The plate may rotate about an axis parallel to a surface facing the plurality of glass substrates.

The glass substrate manufacturing apparatus includes a plurality of plates including the plate, and when the plurality of plates rotate, the plurality of plates may be tilted in a stair shape.

A method of manufacturing a glass substrate according to an embodiment includes preparing a plurality of glass substrates, placing a plate between two adjacent glass substrates of the plurality of glass substrates, and rotating a laminated structure including the plurality of glass substrates and the plate including tilting the plurality of glass substrates and the plate in a stair shape.

Rotating the laminated structure includes rotating the laminated structure in a first rotation direction and rotating the laminated structure in a second rotation direction, and the first rotation direction and the second rotation direction may be opposite to each other.

The rotation axis of the laminated structure may be horizontal to a surface where the plate and the plurality of glass substrates face each other.

The laminated structure may be rotated in an etchant to etch the edges of the plurality of glass substrates.

Edges of the plurality of etched glass substrates may have a round shape.

The plate may include a first base substrate including a protrusion, and a second base substrate including a depression corresponding to the protrusion.

The plate may include a first plate and a second plate, the first plate may include the first base substrate, and the second plate may include the second base substrate.

The first plate may further include a first adhesive layer disposed on a side of the first base substrate, and the second plate may further include a second adhesive layer disposed on a side of the second base substrate.

When the first base substrate and the second base substrate are combined, a space may be disposed between the depression and the protrusion.

The width of the depression may be greater than the width of the protrusion.

The height of the depression may be greater than the height of the protrusion.

According to embodiments, a method and apparatus for manufacturing a glass substrate that provides edges of the glass substrate in a round shape may be provided.

When the edges of the glass substrate are rounded, damage due to fine chipping or cracks at the edges may be reduced.

### BRIEF DESCRIPTION OF THE DRAWINGS

FIGS. 1, 2, 3A, 3B, 4A, 4B, and 5 each are diagrams of a glass substrate manufacturing apparatus according to an embodiment.

FIGS. 6, 7, 8, and 9 each relate to a method of manufacturing a glass substrate using a glass substrate manufacturing apparatus according to an embodiment.

FIGS. 10A and 10B are a diagram of a glass substrate manufactured using a glass substrate manufacturing apparatus according to an embodiment.

### DETAILED DESCRIPTION OF THE EMBODIMENTS

Hereinafter, with reference to the attached drawings, various embodiments of the inventive concept will be described in detail so that those skilled in the art may easily implement the inventive concept.

The inventive concept may be implemented in many different forms and is not limited to the embodiments described herein.

In order to clearly explain the inventive concept, parts that are not relevant to the description are omitted, and identical or similar components are assigned the same reference numerals throughout the specification.

In addition, the size and thickness of each component shown in the drawings are arbitrarily shown for convenience of explanation, so the inventive concept is not necessarily limited to that which is shown.

In the drawing, the thickness is enlarged to clearly express various layers and areas.

And in the drawings, for convenience of explanation, the thicknesses of some layers and regions are exaggerated.

Additionally, when a part of a layer, membrane, region, or plate is said to be “above” or “on” another part, this includes not only cases where it is “directly above” another part, but also cases where there is another part in between.

Conversely, when a part is said to be “right on top” of another part, it means that there is no other part in between.

In addition, being “above” or “on” a reference portion means being disposed above or below the reference portion, and does not necessarily mean being disposed “above” or “on” it in the direction opposite to gravity.

In addition, throughout the specification, when a part is said to “include” a certain component, this means that it may further include other components rather than excluding other components, unless specifically stated to the contrary.

In addition, throughout the specification, when referring to “on a plane,” this means when the target portion is viewed from above, and when referring to “in cross-section,” this means when a cross-section of the target portion is cut vertically and viewed from the side.

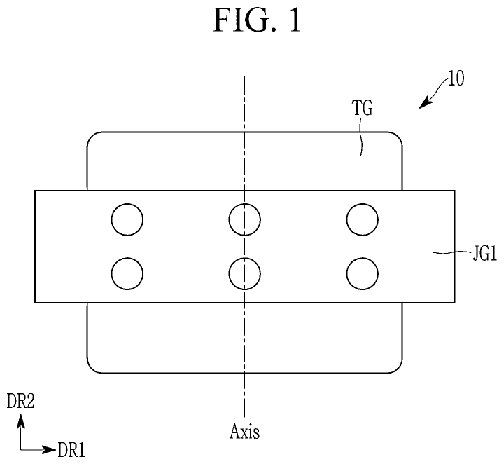

Hereinafter, a glass substrate manufacturing apparatus according to an embodiment will be described with reference to FIGS. 1 to 5.

FIG. 1 to FIG. 5 are diagrams of a glass substrate manufacturing apparatus 10 according to an embodiment.

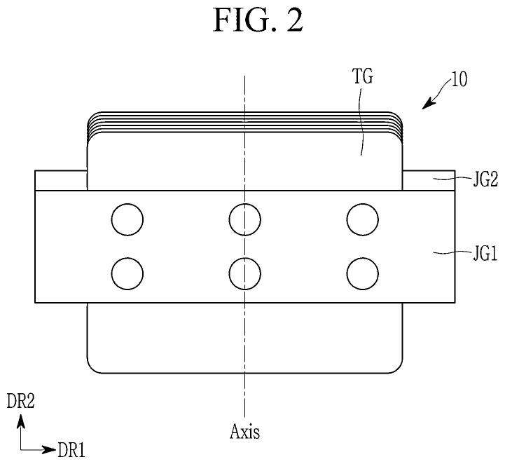

FIG. 1 is a plan view of the apparatus 10 for manufacturing a glass substrate TG according to an embodiment. FIG. 2 is a plan view of the apparatus 10 for manufacturing the glass substrate TG in operation according to an embodiment.

First, referring to FIGS. 1 and 2, the glass substrate manufacturing apparatus 10 according to an embodiment includes fixtures JG1 and JG2 that support the glass substrate TG disposed on the outermost side.

The glass substrate manufacturing apparatus 10 performs a process of etching a plurality of glass substrates TG at once. At this time, the upper surface of the glass substrate TG disposed at the top among the plurality of stacked glass substrates TG may by coupled to the first fixture JG1, and the second fixture JG2 may be coupled to the lower surface of the glass substrate TG disposed at the bottom among the plurality of stacked glass substrates TG.

The plurality of glass substrates TG and the fixtures JG1, JG2 coupled thereto may rotate based on the rotation axis.

The rotation axis may be parallel to the wide surface of the glass substrate TG.

In addition, this specification illustrates an embodiment in which the rotation axis is in the vertical direction DR2 in the drawing, but the inventive concept is not limited thereto and the rotation axis may be in the horizontal direction DR1 in the drawing.

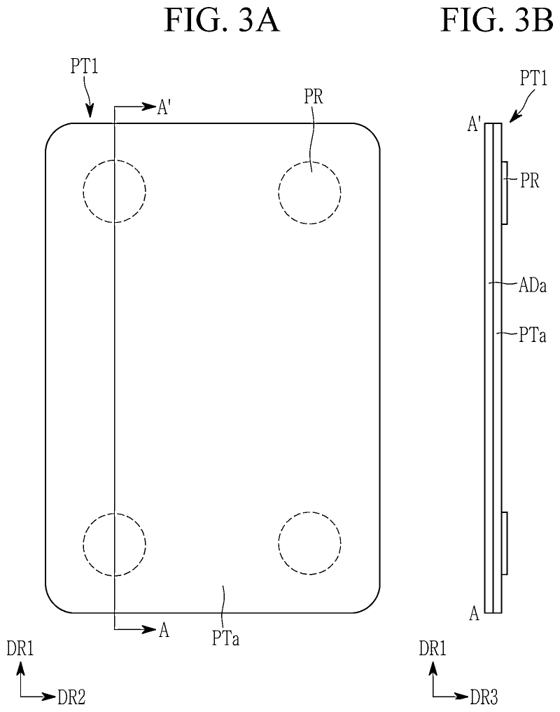

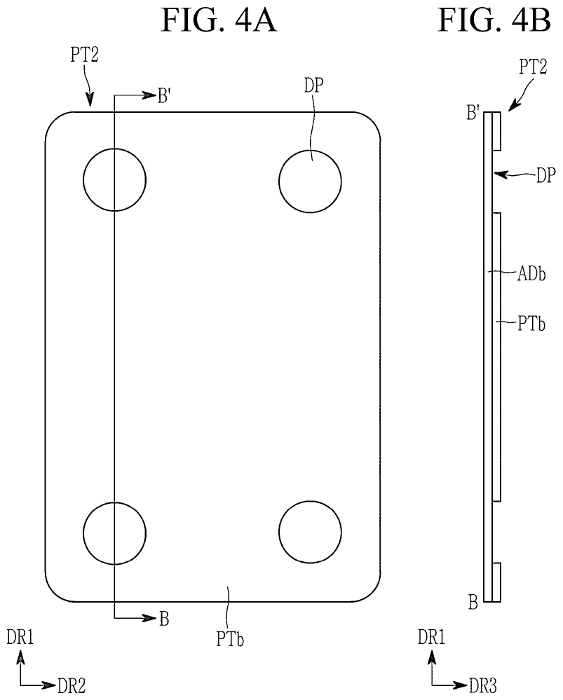

With reference to FIGS. 3A, 3B, 4A and 4B, plates PT1, PT2 included in the glass substrate manufacturing apparatus will be examined.

FIG. 3A is a plan view showing the first plate PT1. FIG. 3B is a cross-sectional view of the first plate PT1 along the line A-A′ of FIG. 3A.

FIG. 4A is a plan view showing the second plate PT2. FIG. 4B is a cross-sectional view of the second plate PT2 along the line B-B′ of FIG. 4A.

An apparatus for manufacturing a glass substrate according to an embodiment may include a plate disposed between adjacent glass substrates TG.

Each plate includes the first plate PT1 including a protrusion PR as shown in FIGS. 3A and 3B and the second plate P21 including a depression DP as shown in FIGS. 4A and 4B.

Referring first to FIGS. 3A and 3B, the first plate PT1 may include a first adhesive layer ADa coupled to the glass substrate TG, and a first base substrate PTa.

The first base substrate PTa may include a protrusion PR.

Referring to FIG. 4, the second plate PT2 may include a second adhesive layer ADb coupled to the glass substrate TG, and a second base substrate PTb.

The second base substrate PTb may include a depression DP.

The depression DP may have a shape corresponding to, e.g., complementary to, the shape of the protrusion PR described above.

The first base substrate PTa and the second base substrate PTb according to an embodiment may be SUS plates, e.g., stainless-steel plates, but are not limited thereto.

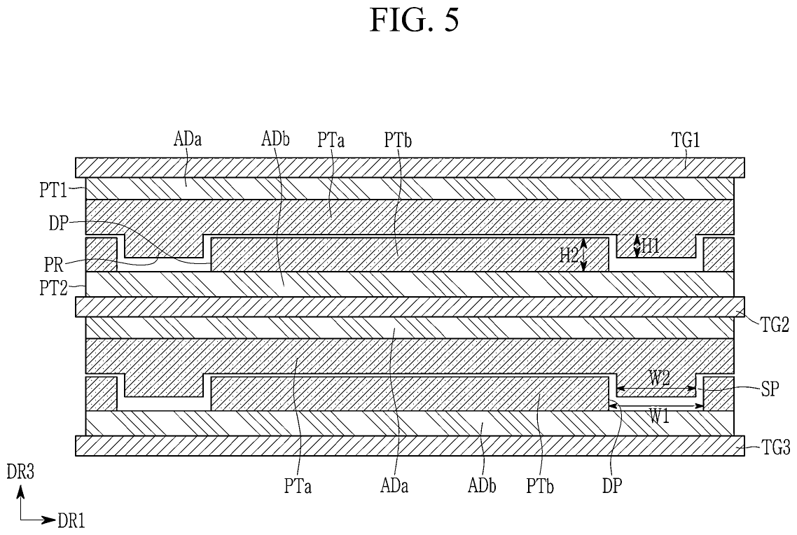

An embodiment in which the above-described plates PT1 and PT2 are combined with the glass substrate TG will be described with reference to FIG. 5.

FIG. 5 is a cross-sectional view of plates PT1, PT2 and a glass substrate TG combined.

Referring to FIG. 5 in addition to the above-mentioned drawings, the first plate PT1 and second plate PT2 may be disposed between two adjacent glass substrates TG1 and TG2.

The first glass substrate TG1 may be coupled to the first adhesive layer ADa, and the second glass substrate TG2 may be coupled to the second adhesive layer ADb.

A first base substrate PTa and a second base substrate PTb may be disposed between the first adhesive layer ADa and the second adhesive layer ADb.

The protrusion PR of the first base substrate PTa may be disposed in the depression DP of the second base substrate PTb.

In this way, the first plate PT1 and the second plate PT2 may be repeatedly arranged between the two adjacent glass substrates TG1 and TG2.

The second glass substrate TG2 and a third glass substrate TG3 may also be arranged in the same manner as described above.

The second glass substrate TG2 may be coupled to the first adhesive layer ADa, and the third glass substrate TG3 may be coupled to the second adhesive layer ADb.

The first base substrate PTa and the second base substrate PTb may be disposed between the first adhesive layer ADa and the second adhesive layer ADb.

The protrusion PR of the first base substrate PTa may be disposed in the depression DP of the second base substrate PTb.

The glass substrate manufacturing apparatus 10 according to an embodiment may include plates PT1 and PT2 disposed between the adjacent glass substrates TG1, TG2, and TG3.

The glass substrates, e.g., including the glass substrates TG1, TG2, TG3, and the plates, e.g., including the plates PT1, PT2, may be arranged alternately.

According to an embodiment, a width W1 of the depression DP may be larger than a width W2 of the protrusion PR.

When the first plate PT1 and the second plate PT2 are aligned and the protrusions PR and depressions DP are combined, empty spaces SP may be formed on sides of the protrusions PR.

As the empty space SP is disposed, the first plate PT1 may move along a first direction DR1 when the glass substrate manufacturing apparatus 10 rotates.

The degree to which the plates PT1 and PT2 move along the first direction DR1 may be determined according to the difference between the width W1 of the depression DP and the width W2 of the protrusion PR. The width W1 of the depression DP and the width W2 of the protrusion PR may be adjusted so that the plurality of plates PT1 and PT2 arranged along a third direction DR3 may implement a stair shape.

A height H2 of the depression DP may be greater than a height H1 of the protrusion PR.

Since the height H1 of the protrusion PR is smaller than the height H2 of the depression DP, the protrusion PR may not contact another adjacent adhesive layer ADb.

The height H1 of the protrusion PR may be appropriately adjusted so as not to contact the adhesive layer ADb.

Additionally, the width of the first plate PT1 and the second plate PT2 may be smaller than the width of the glass substrates TG1, TG2, and TG3.

In a state in which the centers of the glass substrates TG1, TG2, TG3 and the centers of the first plate PT1 and the second plate PT2 are joined to coincide, ends of the glass substrates TG1, TG2, TG3 may protrude beyond the plate PT1 and the second plate PT2.

Ends of the protruding glass substrates TG1, TG2, and TG3 are etched in a glass substrate manufacturing device to have round edges.

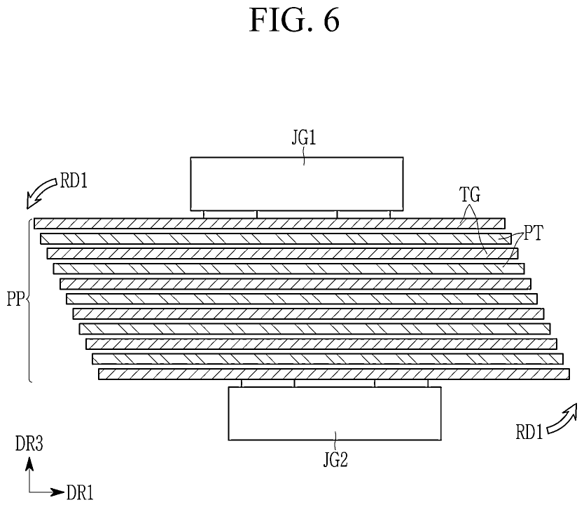

Hereinafter, a method of manufacturing a glass substrate according to an embodiment will be described with reference to FIGS. 6 to 10.

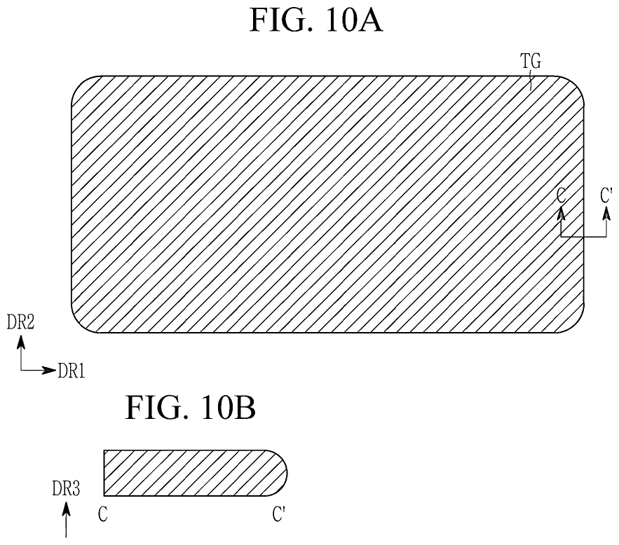

FIGS. 6 to 9 each relate to a method of manufacturing a glass substrate using the above-described glass substrate manufacturing apparatus, and FIG. 10 is a diagram of a glass substrate manufactured according to the method of manufacturing a glass substrate according to an embodiment.

Content that is the same as the above will be omitted.

First, referring to FIG. 6, a plate PT is placed between a plurality of glass substrates TG according to an embodiment.

The plate PT includes the above-described first plate PT1 and second plate PT2.

The first fixture JG1 is disposed outside the glass substrate TG, which is disposed at the top of the plurality of glass substrates TG, and the second fixture JG2 is disposed outside the glass substrate TG, which is disposed at the bottom of the plurality of glass substrates TG.

In this way, the glass substrate manufacturing apparatus mounts the sequentially stacked first fixture JG1, the glass substrate TG, the plate PT, and the second fixture JG2.

Such a laminated structure is referred to as a laminated structure PP.

Such a laminated structure PP is placed in a water tank included in a glass substrate manufacturing apparatus.

An etchant for etching a glass substrate is placed in the water tank.

The laminated structure PP is rotated along a first rotation direction RD1 as shown in FIG. 6.

When rotating according to the first rotation direction RD1, the glass substrate TG disposed at the bottom may move to the right in the drawing.

The glass substrate TG disposed at the top may be moved to the left in the drawing.

The plurality of glass substrates TG disposed between the glass substrate TG disposed at the top and the glass substrate TG disposed at the bottom may have a stair shape that is gradually arranged to the right from top to bottom.

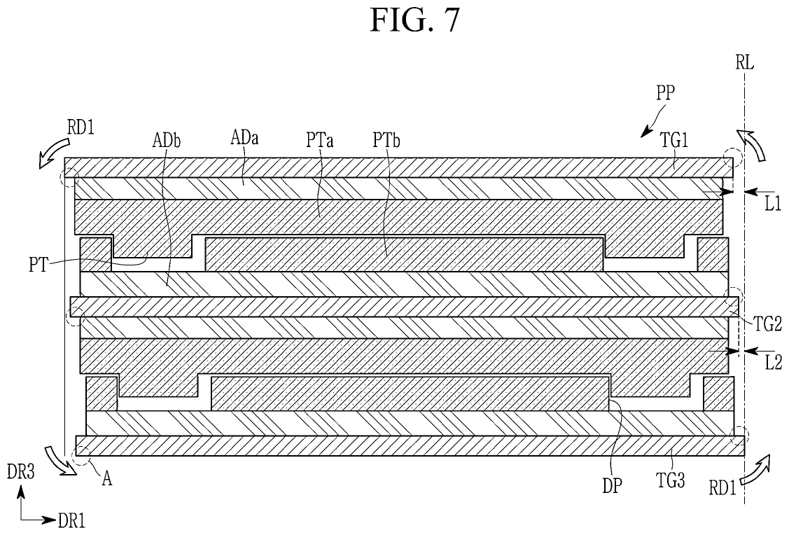

More specifically, the description will be made based on three glass substrates TG1, TG2, and TG3 with reference to FIG. 7.

As the first glass substrate TG1 disposed at the top rotates along the first rotation direction RD1, it may move to the left by a first distance L1 based on the reference line RL disposed on the right.

Additionally, the second glass substrate TG2 may move to the left by a second distance L2 based on the reference line RL as the laminated structure rotates along the first rotation direction RD1.

The laminated structure PP of the third glass substrate TG3 may rotate along the first rotation direction RD1 so that the right edge of the third glass substrate TG3 may overlap the reference line RL.

The first distance L1 may be greater than the second distance L2.

When the laminated structure PP rotates along the first rotation direction RD1, the edges of each glass substrate TG1, TG2, and TG3 may be spaced apart from the reference line RL to different degrees.

The right edge of each glass substrate TG1, TG2, and TG3 may be arranged to have a stair shape with respect to the reference line RL.

When the laminated structure PP arranged in this way is continuously rotated in a water tank containing an etchant, the edges of each glass substrate TG1, TG2, and TG3 are etched.

In particular, the area A indicated by a circular dotted line in FIG. 7 represents an edge where etching is effectively performed when the stacked structure PP rotates in the first rotation direction RD1.

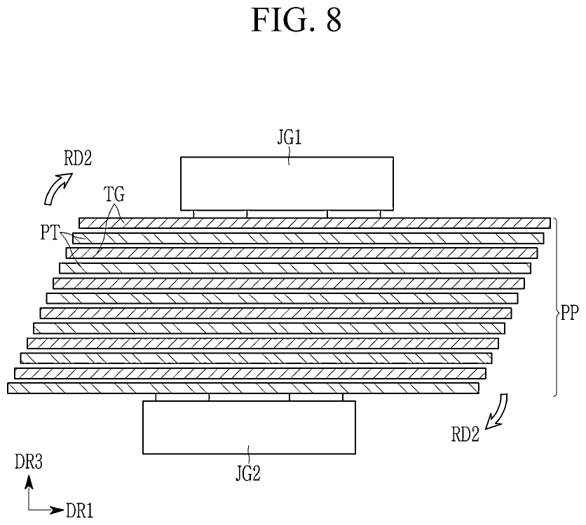

Referring to FIG. 8, the laminated structure PP is rotated along the second rotation direction RD2.

The second rotation direction RD2 is opposite to the first rotation direction RD1.

When rotating according to the second rotation direction RD2, the glass substrate TG disposed at the bottom may move to the left in the drawing.

The glass substrate TG disposed at the top may be moved to the right in the drawing.

The plurality of glass substrates TG disposed between the glass substrate TG disposed at the top and the glass substrate TG disposed at the bottom may be arranged gradually to the left from top to bottom.

The plurality of glass substrates TG may be arranged to have a stair shape.

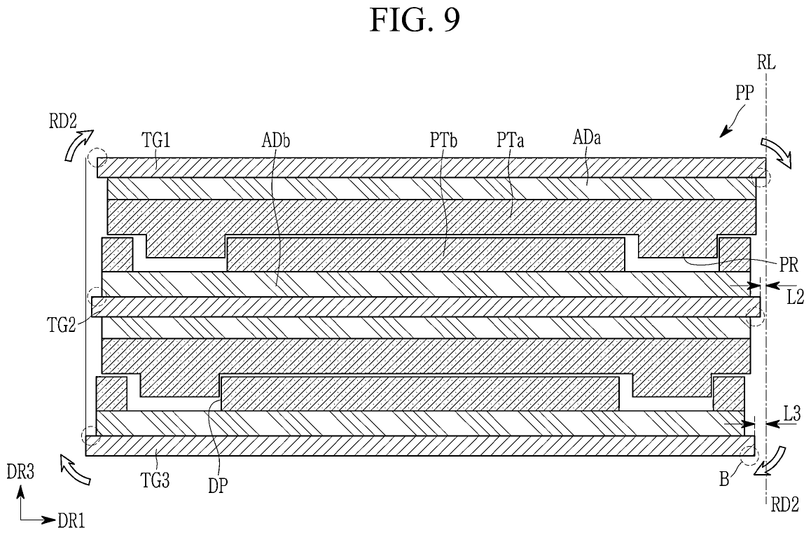

More specifically, the three glass substrates TG1, TG2, and TG3 will be described with reference to FIG. 9.

When the laminated structure PP of the first glass substrate TG1 disposed at the top rotates along a second rotation direction RD2, the right edge of the first glass substrate TG1 may overlap the reference line RL.

Additionally, the second glass substrate TG2 may move to the left by a second distance L2 based on the reference line RL as the laminated structure rotates along the second rotation direction RD2.

As the third glass substrate TG3 rotates along the second rotation direction RD2, it may move to the left by a third distance L3 based on the reference line RL.

The third distance L3 may be greater than the second distance L2.

When the laminated structure PP rotates along the second rotation direction RD2, the edges of each glass substrate TG1, TG2, and TG3 may be spaced apart from the reference line RL to different degrees.

The right edge of each glass substrate TG1, TG2, and TG3 may be arranged to have a stair shape with respect to the reference line RL.

When the laminated structure PP arranged in this way is continuously rotated in a water tank containing an etchant, the edges of each glass substrate TG1, TG2, and TG3 are etched.

In particular, the area B indicated by a circular dotted line in FIG. 9 represents an edge where etching is effectively performed when the stacked structure PP rotates in the second rotation direction RD2.

When the laminated structure PP rotates in the first rotation direction RD1, the edge corresponding to A among the edges of the glass substrate is etched.

When the laminated structure PP rotates in the second rotation direction RD2, the edge corresponding to B among the edges of the glass substrate is etched.

It may be seen that different edges are etched when rotating in the first rotation direction RD1 and when rotating in the second rotation direction RD2.

By changing the rotation direction of the laminated structure PP within the apparatus to proceed with performing the process, all edges may be etched uniformly.

According to the above-described glass substrate manufacturing apparatus and manufacturing method using the same, all edges of the glass substrate may react with the etchant.

As shown in FIG. 10A, the glass substrate manufactured as a result not only has all four corners rounded on the plane, but each cross-sectional shape also has a natural round shape as shown in FIG. 10B.

When a plurality of glass substrates are stacked, different edges may be etched when rotated in different directions.

Additionally, a plurality of glass substrates are arranged in a stair shape in cross-section, and the edges of each glass substrate have a natural round shape.

The reliability of the glass substrate manufactured accordingly may be improved because the occurrence of microscopic breaks or cracks is reduced.

Although the embodiments have been described in detail above, the scope of the inventive concept is not limited thereto, and various modifications and improvements made by those skilled in the art using the basic concepts of the inventive concept defined in the following claims are also possible.

### DESCRIPTION OF SYMBOLS

TG: glass substrate
JG1, JG2: fixture
PT1, PT2: plate
PTa, PTb: base substrate
ADa, ADb: adhesive layer

What is claimed is:

1. An apparatus for manufacturing a glass substrate, comprising:
a fixture coupled to an outermost glass substrate among a plurality of glass substrates, and
a plate positioned between two adjacent glass substrates among the plurality of glass substrates,
wherein the plate comprises:
a first base substrate including a protrusion, and
a second base substrate including a depression complementary to the protrusion.

2. The apparatus for manufacturing a glass substrate of claim 1, wherein:
the plate includes a first plate and a second plate,
the first plate includes the first base substrate, and
the second plate includes the second base substrate.

3. The apparatus for manufacturing a glass substrate of claim 2, wherein:
the first plate further includes a first adhesive layer disposed on a surface of the first base substrate.

4. The apparatus for manufacturing a glass substrate of claim 2, wherein:
the second plate further includes a second adhesive layer disposed on a surface of the second base substrate.

5. The apparatus for manufacturing a glass substrate of claim 2, wherein:
a space is disposed between the depression and the protrusion when the first base substrate and the second base substrate are combined.

6. The apparatus for manufacturing a glass substrate of claim 1, wherein:
a width of the depression is greater than a width of the protrusion.

7. The apparatus for manufacturing a glass substrate of claim 1, wherein:
a height of the depression is greater than a height of the protrusion.

8. The apparatus for manufacturing a glass substrate of claim 1, wherein:
the plate rotates in an axis parallel to a surface facing the plurality of glass substrates.

9. The apparatus for manufacturing a glass substrate of claim 8, wherein:
the apparatus includes a plurality of plates including the plate,
the plurality of plates are tilted in a stair shape when the plurality of plates rotate.

10. A method of manufacturing a glass substrate, comprising:
preparing a plurality of glass substrates,
placing a plate between two adjacent glass substrates of the plurality of glass substrates, and
rotating a laminated structure including the plurality of glass substrates and the plate comprising tilting the plurality of glass substrates and the plate in a stair shape.

11. The method of manufacturing a glass substrate of claim 10, wherein:
rotating the laminated structure includes rotating the laminated structure in a first rotation direction and rotating the laminated structure in a second rotation direction, and
the first rotation direction and the second rotation direction are opposite to each other.

12. The method of manufacturing a glass substrate of claim 10, wherein:
a rotation axis of the laminated structure is parallel to a surface where the plate and the plurality of glass substrates face each other.

13. The method of manufacturing a glass substrate of claim 10, wherein:
the laminated structure is rotated in an etchant, and edges of the plurality of glass substrates are etched.

14. The method of manufacturing a glass substrate of claim 13, wherein:
the edges of the plurality of etched glass substrates are rounded.

15. The method of manufacturing a glass substrate of claim 10, wherein:
the plate comprises:
a first base substrate including a protrusion, and
a second base substrate including the protrusion and a corresponding depression.

16. The method of manufacturing a glass substrate of claim 15, wherein:
the plate includes a first plate and a second plate,
the first plate includes the first base substrate, and
the second plate includes the second base substrate.

17. The method of manufacturing a glass substrate of claim 16, wherein:
the first plate further includes a first adhesive layer disposed on a side of the first base substrate, and the second plate further includes a second adhesive layer disposed on a side of the second base substrate.

18. The method of manufacturing a glass substrate of claim 16, wherein:
when the first base substrate and the second base substrate are combined, and
a space is disposed between the depression and the protrusion.

19. The method of manufacturing a glass substrate of claim 16, wherein:
a width of the depression is greater than a width of the protrusion.

20. The method of manufacturing a glass substrate of claim 16, wherein:
a height of the depression is greater than a height of the protrusion.
